(19) United States
(12) Patent Application Publication
(10) Pub. No.: US 2022/0272092 A1
(43) Pub. Date: Aug. 25, 2022

(54) DECENTRALIZED NETWORK ACCESS SYSTEMS AND METHODS

(71) Applicant: SHAZZLE, LLC, Weymouth, MA (US)

(72) Inventors: Clifford F. BOYLE, Scottsdale, AZ (US); Robert E. MCGILL, Shrewsbury, NJ (US)

(21) Appl. No.: 17/679,289

(22) Filed: Feb. 24, 2022

Related U.S. Application Data
(60) Provisional application No. 63/153,014, filed on Feb. 24, 2021.

(51) Int. Cl. H04L 9/40; H04L 67/104

(52) U.S. Cl. CPC H04L 63/10; H04L 67/104

(57) ABSTRACT

The decentralized network access systems and methods include networking computers through a decentralized registry of content and user network locations managed by a cooperative network of users (peers), where any and all peers may discover and deliver resources or resource locations to any other peer. The decentralized network access systems and methods determine an optimal route through a computer network from which to receive a network resource. The decentralized network access app establishes a network of users who can become nodes on potential network paths, sharing location information of requested resources through a network of peers. The systems and methods of the invention provide multiple paths to resources, avoiding firewalls and other blocked network paths, while providing additional layers of reliability to networks.

### CROSS-REFERENCE TO RELATED APPLICATIONS

This application claims benefit of priority of U.S. Provisional Patent Application No. 63/153,014, filed on Feb. 24, 2021. This application incorporates by reference the entire contents of the provisional application.

### TECHNICAL FIELD

This technology relates generally to peer-to-peer information systems and particularly to such systems that conduct secure electronic payment transactions. More specifically, the technology relates to secure electronic payment systems that incorporate customer identity verification using cross-referenced multiple data sources.

### BACKGROUND

Peer-to-peer networking and peer-to-peer computing (P2P) may be applied to a wide range of technologies that greatly increase the utilization of information, bandwidth, and computing resources of the Internet. P2P technologies often adopt a network-based computing style where computers (“nodes”) are connected together via communication links and work together by sharing resources. Network-based computing neither excludes nor inherently depends upon centralized control points. One basic model of network computing includes centralized computing, where computing is done at a central location, using terminals that are attached to a central computer, such as in a client-server environment. Another model of network-based computing is decentralized computing, where computing is done at various individual stations or locations, each of which has the ability to run independently. Network-based computing styles can improve the performance of information discovery, content delivery, and information processing, and can enhance overall reliability and fault-tolerance of computing systems.

Peer computers share files and access to devices without requiring a separate server or server software. P2P utilize distributed application architectures that partition tasks and workloads between peers. Peers are equal participants in the applications. Peers make a portion of their resources, such as processing power, disk storage, and network bandwidth, directly available to other network participants (peers), without the need for central coordination by servers or stable hosts. Peers are both suppliers and consumers of resources, in contrast to traditional (centralized) client-server models in which the consumption and supply of resources is divided.

Peer-to-peer networks generally implement some form of virtual overlay network on top of the physical network topology, where the nodes in the overlay form a subset of the nodes in the physical network. Data is still exchanged directly over the underlying TCP/IP (physical) network, but at the application layer, peers are able to communicate with each other directly, via the logical overlay links (each of which corresponds to a path through the underlying physical network). Overlays are used for sharding and peer discovery, and make the P2P system independent from the physical network topology. Depending on how the nodes are linked to each other within the overlay network, and how resources are sharded and located, networks can be classified unstructured or structured (or as a hybrid between the two). Structured P2P networks are formed when the overlay links are established arbitrarily, and structured P2P networks maintain a distributed hash table (DHT) or other lookup service to allow each peer to be responsible for a specific part of the content in the network.

Typically, presence information (i.e., a status indicator that conveys the ability and willingness of a potential communication partner to communicate) is stored centrally on a single server or a cluster of servers. For example, presence information can be sent to a presence service (server) that records and distributes presence information. Remote service providers and remote service requesters find the presence server to register or to request a service.

Discovery of the presence of a computer in a peer-to-peer environment may be based on centralized discovery with a centralized registry of peers. The central server maintains a registry of the data or files that are currently being shared by active peers. Each peer maintains a connection to the central server, through which the queries are sent. These systems with a central server are simple, and they operate quickly and efficiently for discovery information. Searches are comprehensive and they can provide guarantee in searches. Discovery of content based on a centralized registry of content may be efficient, deterministic, and well suited for a static environment. Such methods of discovery may also provide centralized control, provide a central point of failure, and provide easy denial of services. However, a method of discovery based on a centralized registry of content can be expensive to scale, and is vulnerable to censorship and malicious attack because the central servers have a single point of failure. Such methods also are not inherently scalable because of limitations on the size of the database and its capacity to respond to queries. Central directories also may not always be updated, and they have to be refreshed periodically.

Discovery in a peer-to-peer environment may also be based on net crawling. Net crawling is a systematic browsing of network locations and an indexing of the results of the browsing activities. Indexing can include identifying and cataloguing attributes of a document or resource to simplify and expedite accurate retrieval of the document. Net crawling presence discovery can be used to map identities and resolve the locations of the corresponding entities and the resources they provide. Discovery based on net crawling can be simple, adaptive, deterministic, inexpensive to scale, well suited for a dynamic environment, and can be difficult to attack. Such a method of discovery can also improve with aging. However, such a method of discovery often provides slower discovery than centralized control, and there is no guarantee about quality of services.

Decentralized indexing incorporates a central server that registers the users to the system and facilitates the peer discovery process. In these systems, some of the nodes assume a more important role than the rest of nodes. They are often called supernodes. These supernodes maintain the central registries of content for the information shared by local peers connected to them and proxy search requests on behalf of these peers. Queries are sent to the supernodes and not to other peers. Kazaa and Morpheus were two P2P file sharing applications that were similar decentralized indexing systems. In such systems, peers are automatically elected to become supernodes if they have sufficient bandwidth and processing power and a central server provides new peers with a list of one or more supernodes with which they can connect.

In comparison with purely decentralized systems, these systems reduce the discovery time, and they reduce the traffic of messages exchanged between nodes. In comparison with centralized indexing, they reduce the workload on the central server, but they present slower information discovery. Also, in these kinds of systems, there is no unique point of failure such as a single central server. If a supernode goes down, the nodes connected to it can open new connections with others, and the network will continue to operate. If a large number of supernodes fail, or if all supernodes go down, the existing peers become supernodes themselves.

Distributed peer-to-peer systems often require a discovery mechanism to locate specific data within the system. P2P systems have evolved from first generation centralized structures to second generation flooding-based systems and to third generation systems based on distributed hash tables. Centralized registries of content and repositories are used in hybrid systems. In these models, the peers of the community connect to a centralized directory server, which stores all information regarding location and usage of resources. Upon request from a peer, the central registry of content will match the request with the best peer in its directory for that particular request. The best peer could be the one that is cheapest, fastest, nearest, or most available, depending on the user needs. Then the data exchange will occur directly between the two peers. Napster used this method. A central directory server maintains a registry with metadata (e.g., file name, time of creation, etc.) of all files in the network, a table of registered user connection information (e.g., IP addresses, connection speeds etc.), and a table listing the files that each user holds and shares in the network. Initially, a client contacts the central server and reports a list of the files it maintains. When the server receives a query from a user, it searches for matches in its registry, returning a list of users that hold the matching file. The user then opens a direct connection with the peer that holds the requested file, and downloads or otherwise accesses it.

In the flooding broadcast of queries model, each peer does not maintain a central directory, but rather each peer publishes information about the shared contents in the P2P network. Because no single peer knows about all resources, peers in need of resources flood an overlay network with queries to discover a resource. Each request from a peer is flooded (broadcasted) to directly connected peers, which themselves flood their peers, etc., until the request is answered, or a maximum number of flooding steps occur. Flooding-based search networks are built in an ad hoc manner, without restricting a priori which nodes can connect or what types of information they can exchange. Although the flooding protocol might give good results in a network with a smaller number of peers, it does not scale well. Furthermore, accurate discovery of peers is not guaranteed in flooding mechanisms.

Routing models add structure to the way information about resources is stored by using distributed hash tables. This protocol provides a mapping (in the form of a distributed routing table) between a resource identifier and a location so that queries can be efficiently routed to the node with the desired resource. This protocol reduces the number of P2P hops that must be taken to locate a resource. A look-up service is implemented by organizing the peers in a structured overlay network, and routing the message through the overlay to the responsible peer.

To date, prior architectures for presence discovery have problems associated with centralized architectures and decentralized systems, including lack of scalability and capacity to respond to queries, vulnerability to censorship and malicious attacks, and lack of reliability because the central servers have a single point of failure. The purely decentralized systems present slower information discovery, and a conventional registry can be too resource-intensive to maintain on a limited resource peer, such as a smartphone, or on other computing devices that have limited resources.

### SUMMARY

“Decentralized Network Access” (DNA) in accordance with the invention includes computer systems and methods of networking computers through a decentralized registry of user network locations, including IP (and other) addresses of desired parties and resources (content). The decentralized registry is managed by a network of users (peers) on their personal computing devices (PCDs). PCDs can be personal computing devices, such as desktop computers, laptop computers, smartphones, tablets, and other computing devices. Peer PCDs are those personal computing devices of the users of the network.

The systems and methods in accordance with the invention provide multiple communication (e.g., data delivery) paths through a network. In one example implementation of the invention, a DNA app establishes a network of users who can become nodes on potential paths, sharing location information of requested resources through a network of peers, where peers are other network users on personal computing devices. The systems and methods of the invention provide universal access around firewalls and other blocked network paths, and provide additional layers of reliability to networks. The invention overcomes many shortcomings of current Internet browsers' use of a single path to a web resource that either works, or fails.

The invention incorporates the use of two registries. A Peer Registry holds information related to all peers within the network and is referenced for requests by peers and for information on potential responsibilities (e.g., shards held, etc.) within the network. The Peer Registry can be used to store and reference user ratings, shard expert status (discussed below), and diagnostic data. The Peer Registry can be queried by peers for this information and can be used to modify user ratings and responsibilities. A DNA Content Registry holds information related to all resources and their resource locations (i.e., network addresses that allows the user to access the resource) across the network. In one embodiment of the invention, the peers establish a network connection with a requesting peer (i.e., a requesting party) or resource. Each DNA network member (peer) runs a DNA application in accordance with the invention. The information gathered from those DNA applications (which can be IP addresses, DNS locations, or other network locations) are held in the Peer Registry, which includes a registry of peer network locations. A conventional peer registry can be too resource-intensive to maintain on a limited resource peer like a smart phone, or on other computing devices with fewer resources than a configuration of servers. The DNA apps of the invention subdivide the Peer Registry and parcel out the shards to store on various peer PCDs. A shard is a segment or portion of the DNA Content Registry, and a peer shard is a segment or portion of the Peer Registry. The shards are distributed among the peers so that peers within a particular group (a “Pod”) will collectively hold a complete copy of the DNA Content Registry. Likewise, the peer shards are distributed among the peers so that peers within a particular Pod collectively hold a complete copy of the Peer Registry.

In some example implementations of the invention, the various shards of the DNA Content Registry are divided onto the peer PCDs in different sizes, with the size of the DNA Content Registry shard determined by characteristics of the peer's DNA network account. The peer's DNA network account is an account that a peer creates and uses when operating within the DNA network. The DNA network account includes information about the peer's PCD, the PCD's capabilities, the peer PCD interactions with other peers, and the peer PCD's responsibilities within the DNA network. The peer interactions can be stored in a log file (Device Log) stored locally on the peer's device. The log file is updated locally and shared with the DNA Content Registry and Peer Registry to update User Ratings. Responsibilities can include holding segments (shards) of the DNA Content Registry and providing access and relays to resource locations. A relay is a network peer that acts as a proxy for the requesting peer for resources that the requesting peer cannot reach.

The peer's DNA network account also can include diagnostic information related to the peer's PCD, such as computational power, available memory, and connection speed, for example. These characteristics can be determined during the creation of the peer's DNA network account. Peers can determine the size of the DNA Content Registry files they handle, while the DNA app can access peer PCD hardware characteristics to determine the size and type of DNA Content Registry it can optimally handle. Peer PCDs are assigned DNA characteristics that relate to commonly-searched-for-and-accessed shards. The DNA characteristics can be used to determine groupings of DNA Content shard holders to optimize use of the DNA network. The DNA Content shards are assigned characteristics, so it is possible to match the PCD characteristic (or combination of PCD characteristics) that is most likely to find the DNA Content shards sought. For example, peers who most often connect to each other can be grouped in the same Pod.

Peer PCD network locations can change frequently, so the DNA Content Registry is updated in real time. The peers that collectively hold shards making up a complete distributed DNA Content Registry form a Pod, and each Pod maintains a registry of peer PCD network locations, as well as a record of shard characteristics so that the peers can calculate the most efficient path to a requested resource at a network location. Characteristics of the network location peer PCD (such as last known network location, likely geographic location, etc.), if known, provide data to help calculate the path to the shards. Peers update their network location to the Pod when the peer's network location changes. They may periodically confirm their location to the Pod between changes. The DNA apps determine Shard Experts for the Pod based on availability (e.g., a peer application is active and connected) and characteristics of the peer DNA network account. A Shard Expert is a designated holder of a shard. Shard Experts are responsible for sharing their shared resources with any requesting peers or Shard Experts. For example, peers who are most often connected to the network may be selected as the Shard Expert ahead of peers less often connected. A backup of the DNA Content Registry is updated to a DNA main server. A backup of the DNA Content Registry may also be updated on Shard Experts in other Pods for redundancy. If the connection to an initial Shard Expert is interrupted, the system hands off the resource request to the next available peer PCD with the highest User Rating. User Ratings are associated with each peer on the network. User Ratings are determined by the peer's reliability (e.g., its ability to maintain a connection to the DNA network with minimal downtime) and its information quality (e.g., its ability to provide accurate direction to resource locations for requesting peers) and its behavior within the network. A shard version control number is maintained and is updated with each modified version of the shard. If a Shard Expert loses its connection before completing a shard handoff, the backup Shard Experts note the version control number of the last shard received from the temporarily dark (disconnected) Shard Expert. The backup Shard Expert with the highest rating becomes the primary Shard Expert. When the temporarily dark Shard Expert reconnects, the temporarily dark Shard Expert sends its last version control number to the (primary) Shard Expert to be checked against the version control number noted when the initial Shard Expert went dark. If the version control numbers do not match, the primary Shard Expert will compare all shard changes against its current shard and update all those resource locations which had not already been updated from the time the Shard Expert disconnected.

The DNA apps in accordance with the invention maintain a DNA Content Registry in a standard DNS-type configuration, which peers can access through a network location query to a central, static location with significant hardware resources to maintain the registry, such as a server, for example. The DNA Content Registry holds information related to all resources and their resource locations across the network. The DNA Content Registry can be used as a primary network location service, or as a backup network location service. In an additional implementation of the invention, the peer seeking the network location of a network resource checks its DNA Content shards for the (peer) network location to which it seeks to connect. If the requesting peer fails to find the network location of the desired resource within their known list of DNA Content shard holders, the requesting peer's DNA app will determine characteristics of a peer being sought and identify other peers in the DNA network that hold the DNA Content shards of the desired resource. The requesting peer's DNA app calculates the most efficient search path to locate a DNA Content shard where the sought peer's network location is stored. The DNA app sends a query to the sought peer's DNA contacts. The peer's DNA contacts can include other peers, including peers based on common characteristics, such as DNA cooperative relationships to the seeking peer, such as contacts in chat relationships, or other connected communities, for example. The query can use peer suitability characteristics to determine the optimal query targets. Suitability characteristics can include peer registration status (e.g., indication of willingness or ability to handle traffic), network attachment status, bandwidth speed, ability to avoid blocks or firewalls, geo location, and other suitability characteristics.

Some of these suitability characteristics include information that can change moment to moment, so the DNA apps track and update the DNA Content Registry, the Peer Registry, and all related shards in real time as described above. The DNA Content Registry can be the DNA Main Server in the FIGS. below. When a DNA Content sub registry (shard) is updated, the update is propagated to all related sub registries (shards) as well as to the DNA Content Registry (DNA Main). The same methodology applies to the Peer Registry. The DNA apps use real time DNA Content Registry and Peer Registry information to maintain connections during an update, such as an IP address change. The DNA apps can maintain an open connection during updates.

If the DNA contacts of the peer seeking the resource do not maintain a DNA Content shard that includes the resource's network location, those DNA contacts can query their peer DNA contacts, who can then contact their peer DNA contacts, who can then do the same through multiple degrees of separation (layers), until the network location with the desired DNA content shard is found. Once the desired DNA content shard is located, the network location of the peer that has the desired DNA content shard is returned to the original seeking peer, who now establishes a network connection with the peer with the desired DNA content shard. Once the connection is established, they exchange data and communications in a P2P configuration.

As the DNA network grows, the number of potential paths to access peer network location information grows as well. The DNA systems and apps in accordance with the invention establish and maintain a decentralized Peer Registry of network user (peer) locations, such that there are multiple possible paths to identify a peer's network location. The potential paths radiate from the requesting user (peer) to a first layer of peers. Each of the first layer of peers has paths that radiate to their peers on a second layer. This interconnection is akin to a hierarchical network topology that interconnects multiple groupings of peers (peers/PCDs) that are located on the separate layers that form a larger network. If one path is blocked by a firewall, or other interruption, many other paths to the peer with the required DNA content shard are available. Once the network location is identified, peers can establish a network connection with the identified peer, and exchange data in a P2P path.

The invention overcomes many shortcomings of current Internet browsers' use of a single path to a web resource that either works or fails. The DNA apps establish a network of users who can become nodes on potential paths, sharing location information of requested resources through a network of peers. The systems and methods of the invention provide universal access around firewalls and other blocked network paths, and provide additional layers of reliability to networks.

In addition, the systems and methods of the invention include hardware and software configured to expand the capabilities of new and existing resources and services. The Internet uses a command-and-control configuration. Services (such as web sites) are made available on a centralized basis, and consumers of these services locate them via a distributed index called the Domain Name System (DNS). These services are static and are supported by expensive infrastructure designed to handle very large network traffic loads and provide very high reliability. In order for a consumer (a user) of a service to use or access the service, the user must have an open (available) path to that service. Intermediaries such as Internet Service Providers (ISP) and national entities regulate the discovery and access to these static services such that the experience of a service consumer (user) varies greatly depending on the location from where the user is accessing the service. For example, consumers may be blocked from accessing a DNS server by a firewall established at the ISP or at the national level. Also, ISPs may slow services down to provide economic incentives to consumers to choose alternative services, or otherwise pay to avoid slowdowns.

In addition, because the services on the Internet are static, there are natural choke points at which intermediaries can surveil and record the network traffic between service consumers and service providers. Networks that allow computer interactions of more than one computer must create or incorporate communication protocols to ensure that the commands that pass between the different computers are mutually recognized and can be acted upon in a consistent manner regardless of which computing machine is acting on the commands. If this mutual recognition fails, the network fails. For this reason, network (communication) traffic must be encrypted if it is to remain private.

Even when encrypted, network traffic yields information about the consumption of services and patterns of access. Where networks are centrally managed, the network traffic (communication) can be centrally accessed. This information can provide a very detailed assessment of the nature of the consumer of the service. For example, it is not necessary to know what data is being accessed on a protest web site in order to ascertain that a consumer of that service is sympathetic to the protest's cause. The mere act of regular access would indicate possible membership. The DNA systems and methods in accordance with the invention do not incorporate a central control and do not need to create such detailed information about its users.

In many conventional networks where there is a single point of access, there also is a single point of failure. Where there is central control, there also is consolidation of authority. The Decentralized Network Access (DNA) systems and methods of the invention avoid these single points of failure and central control while maintaining communication and other protocols necessary for the network to properly function. Responsibility for maintaining the network falls on the users of the network, so liability rests with individual users as well. The political ramifications of this can be disruptive. There can be no central authority over a network established by the DNA systems and methods in accordance with the invention. As such, there is no single point or provider over which legal and/or political authority is established. Decentralization makes it more difficult for a central authority to restrict content and data flow. The DNA systems and methods of the invention allow nodes to reach each other without either of them using local Internet access points. The decentralized network access systems of the invention make it difficult for a central authority to disable determined individuals that seek to establish network connections, other than by shutting down all ability to create networks.

The DNA systems and methods of the invention provide technical solutions to challenges faced by previous systems. The DNA systems and methods include specialized computer processors and memory configurations to deliver additional capabilities for establishing multiple paths to multiple DNA Content sub registries. These multiple paths ensure universal access around firewalls and other blocked paths. The systems and methods of the invention provide additional layers of reliability, as there is no single path to a resource. The decentralized DNA Content Registry conserves computing resources including database storage media and processing and locating speeds, especially with regard to mobile computing devices. Further DNA Content registries can be assigned based on identified characteristics to make short and quick connections from peer-to-peer the rule. Additionally, the DNA Content sub registries (shards) are updated in real time and maintain network connections during updates to ensure that registry and resource location information is current and up to date.

The invention extends capabilities of existing decentralized systems. In conventional systems, such as The Onion Router (TOR), the nodes are static servers that use routing tables. The inventors of the DNA system used a dynamic peer-to-peer architecture to change on the fly and to solve the problems of these static nodes being blocked, which would previously render the network unusable. Many conventional systems are not mesh networks and do not add and remove peers on the fly, using different connection status, for example. The mesh network in accordance with the invention keeps track of peers that are available as well as their status. A suite of services is used to deploy the mesh network, and the network tracks availability of network peers one hop away in the mesh as well as websites (TCP/IP locations) that each peer can access.

This differs from TOR in that the invention can discover multiple paths to a website, so that if a user is blocked from a website IP address by a central authority, the user can access the website content through a different peer on the network who is not blocked. For example, a user in the People's Republic of China may use TOR to try to access a forbidden website, and if successful, can gain access without being tracked. If, however, the website is blocked by their Internet service provider (ISP), TOR cannot help them gain access. The present invention, on the other hand, can route the user, through network peers, to peers that are not blocked by the ISP and so can connect the user to the previously inaccessible website. Additionally, the systems and methods of the invention can route the content (resources) from that previously inaccessible website to the original Chinese user via relays.

Previous systems resolved to a DNS domain and provided hidden access to users. The systems and methods of the claimed invention can provide the IP address of the domain and does not need to resolve to DNS.

Conventional systems (including TOR) are anonymous and do not know which users are accessing the system nor what resources they are accessing. However, authorities do track the accessed sites. Prior systems created a network of peers with just a single path to a resource destination but have many users who can access the resource and then share the location between users. Prior systems route and forward requests. Users ask those systems for the webpage content, the system requests the content from a server, who gives content to the system, who then delivers the content to a user via a path of multiple nodes.

The systems and methods of the invention use an alternative network architecture and routing structure based on peer-to-peer networks. Potential new paths are constantly identified and created. In prior systems, paths are established first, and then a user uses a path that is available. Access to these prior networks is through a server, which can be blocked. Prior systems are supported only by those users that choose to become servers. To block the systems and networks of the claimed invention, all users must be blocked. All users/peers support the network of the claimed invention.

The present invention is also different from Zigbee and other similar mesh P2P networks. The present invention maintains routing tables that track which network peer can connect requesting peers to the content they need, with these routing tables being constantly updated by the activity on the network. Conventional mesh networks, such as Zigbee for example, are proximity based and require that every device on its network have a uniform (same) routing table that is not updated. As the network is used, Zigbee users cannot add resources or addresses to the registry. The present invention does not limit who can “join” the network, nor does the invention limit the resources (as contained in the routing table) to which the network can point. Additionally, the present invention establishes paths to resources outside the network.

Users of the systems and methods of the invention track the resource locations (on the Web or elsewhere) that they can access. Each user maintains a table of such locations that it is able to share with its peers. Likewise, those peers share their resource locations with the user. Peers can request the resource locations from other peers. If those peers do not have the resource location, they in turn can ask still other peers, and so on, until such resource location is discovered, and it can be routed back to requesting peer. This function is not found in existing mesh networks.

Bluetooth and NFC (and Ethernet) are point-to-point only, and have no routing ability. TCP/IP does use routers with routing tables, but their tables are not segmented. Each copy is the entire table. Further, it requires DNS, so it cannot be used if an IP address is blocked by a user's ISP. In contrast, the present invention can route outside or around the ISP firewall and deliver the desired resource indirectly to the requesting user.

The systems and methods of the invention distribute registry information to peers on a decentralized computer network. The methods include utilizing a requesting peer to request a network resource from a plurality of additional peers. The requesting peer is a peer on the decentralized computer network interconnected to the plurality of additional peers. The peers on the decentralized network are configured to discover and deliver network resource locations and network resources to other peers on the network, and no pre-established route or address, nor pre-defined peer or group of peers, is responsible for accessing and/or delivering the network resource location or the network resource. The systems and methods of the invention also have the requesting peer receive an affirmative response from at least one of the plurality of additional peers. The affirmative response indicates that the at least one additional peer has access to the requested network resource.

The systems and methods of the invention not only allow for “n” number of paths to a resource, but also each peer can contain the resource being requested. The system architectures and algorithms provide for all peers to be eligible as responsible registry providers, but not all peers are required to be responsible registry providers. The invention enables all peers to provide resources, even if they do not do so. This is very different from client-server architectures, where clients do not provide resources.

In some example embodiments of the invention, the requesting peer receives the network resource location of the requested network resource from the at least one additional peer. Additionally, in some implementations of the invention, the requesting peer receives the network resource from the at least one additional peer.

Some implementations utilize registry information that includes a DNA Content Registry of network resource locations identifying a location of the requested network resource. Requesting a network resource in some examples includes the requesting peer polling a first set of peers, where the first set of peers are a subset of the plurality of additional peers having a first degree of separation.

In some embodiments of the invention, the registry information is a DNA Content Registry of network resource locations, and the method includes sharding the DNA Content Registry of network resource locations into shards. Sharding includes dividing the DNA Content Registry, and the shards are sub registries of the DNA Content Registry. In some instances, the systems and methods of the invention distribute the shards to at least one of the plurality of additional peers.

Some implementations of the invention form at least one of the plurality of additional peers into one or more Pods, where a Pod is a group of peers holding a shard of the DNA Content Registry. In some implementations, the methods further include the one or more Pods storing a shard such that when the Pod's shards are combined, the combination of shards constitutes a complete DNA Content Registry.

Some implementations of the systems and methods of the invention utilize a Shard Expert in the one or more Pods to deliver a network resource location associated with their shards to at least one of the plurality of additional peers. The Shard Expert is a designated holder of a shard responsible for sharing their shard with a requesting peer.

In some examples of the invention, the requesting peer determines shards that include a network resource location of the requested network resource, identifies a Shard Expert based on the determined shards, and request the location of the network resource from the Shard Expert. The Shard Expert is a responsible peer that has the network resource location of the requested network resource. In some cases, the Shard Expert does not have the requested network resource location, and the systems and methods request an alternative network resource location from a Shard Expert Group, where the Shard Expert Group is a collection of Shard Experts from separate Pods, each of whom hold some portion of the same DNA Content Registry information in their shard.

Some example implementations of the invention have the requesting peer repeatedly request the network resource location until the requesting peer receives the network resource location or the request is failed. In some examples, the first set of peers who have been polled for the network resource location do not have the network resource location, and the invention further requests the network resource location, by at least one peer in the first set of peers who has been polled for the network resource location, until the at least one peer in the first set of peers receives the network resource location and returns it to the requesting peer or the further request is failed.

Some example systems and methods of the invention have a Shard Expert in the one or more Pods update network resource locations to peers in the same one or more Pods. Further, a peer in the one or more Pods receives a network resource location updates for a shard that they do not hold and update the network resource location to a Shard Expert in the same Pod that is designated to hold the network resource location.

In some example implementations of the invention, the peers on the decentralized network record their interactions with other peers in a Device Log, and the Device Logs are uploaded to a Peer Registry to record reliability and suitability for responding to and resolving peer responsibilities. The Peer Registry provides peer characteristics to requesting peers upon request and prior to connecting with another peer. In some examples, the peer characteristics include a success rate of a peer in delivering network resource locations.

The systems and methods of the invention send and receive resources to and from peers over a peer-to-peer network. In some example implementations of the invention, the resources are accessed through relay nodes based on a registry of resource locations, where any and all peers can discover and deliver resources or resource locations to any other peer, and no pre-established route or address or pre-defined peer or group of peers, is responsible for accessing and/or delivering the resource or resource location. Establishing and accessing the relay nodes includes the requesting peer requesting relay suitability characteristics from a Peer Registry. The requesting peer receives a relay node location based on the relay suitability characteristics that meet relay requirements of the requesting peer. The requesting peer connects to the relay node location.

In some examples of the invention, the requesting peer contacts other peers on the peer-to-peer network to request the relay to deliver the requested resource until the requesting peer receives the resource, or the request is failed. In some implementations, the relay node is established based on its relative processing ability to access the requested resource. The relative processing ability includes responding to the requesting peer that the relay node has access to the requested resource, and the relay node is accessed by providing the requesting peer with access to the requested resource.

In some examples of the invention, an optimal relay node is determined based on relay node's capabilities, reliability, and conduct within the network. The peer's capabilities, reliability, and conduct include at least one of the group of network status, connection speed, connection reliability, geo location, resource access, interactions with other peers, and DNA account information.

The systems and methods in accordance with the invention provide multiple data paths through a network. The DNA apps establish a network of users who can become nodes on potential paths and share location information of requested resources through a network of peers. The systems and methods of the invention provide universal access around blocked paths, firewalls, and other obstructed network paths and provide additional layers of reliability to networks. The invention overcomes many shortcomings of current Internet browsers' use of a single path to a web resource that either works or fails.

### BRIEF DESCRIPTION OF THE DRAWINGS

FIG. 1 shows an example block diagram of a Decentralized Network Access system in accordance with the invention servicing a request for a resource.

FIG. 2 shows an example architecture and process of a peer requesting a relay to use to access a resource.

FIG. 3 illustrates an example architecture and process of a shard creation and assignment of peers to a Pod.

FIG. 4 illustrates an example architecture and process of shard propagation from a DNA main computer in accordance with the invention.

FIG. 5 illustrates an example architecture and process of shard propagation from Shard Experts in accordance with the invention.

FIG. 6 illustrates an example architecture of the Peer Registry and DNA Content Registry in accordance with the invention.

FIGS. 7A-7B illustrate an example architecture and process of finding a resource using Shard Expert Groups.

FIG. 8 shows an example architecture and process of finding a resource while taking into account search hops and degrees of separation of peers.

FIG. 9 shows an example onboarding process where new users/peers join the decentralized network of peers.

FIG. 10 shows an example architecture and process of a user finding a resource using a relay.

### DETAILED DESCRIPTION

In the example DNA routing algorithm described below, computer “nodes” are used synonymously with “peers.” The DNA (Distributed Network Access) computer architecture in accordance with the invention includes systems and methods of finding, requesting, and retrieving resources across a wide area mesh network. One wide area mesh network is a geographically dispersed network with user computing devices (network nodes, peers, etc.) that dynamically and automatically join and leave the network when these devices are turned on/off and when the devices gain/lose connectivity to the network. The DNA systems and methods of the invention are designed and manufactured for high reliability and censorship resistance. Resources accessed over a DNA system in accordance with the invention can be conventional web sites, files on a file system, or other network content and services. The DNA networks include peers that run DNA software apps that provide communication services for the location, identification, requesting, and retrieval of computing resources, such as web pages, files, and other computing resources. The DNA network peers can be both fixed position computer devices such as servers and desktop computers as well as mobile computer devices such as laptops and smart phones.

The invention overcomes many of the shortcomings of existing systems as any peer can request resources via the Peer Registry. Any peer can locate information regarding a requested resource. Any peer can deliver the requested resource. Conventional systems put a subset of peers in charge of the resource location and delivery processes.

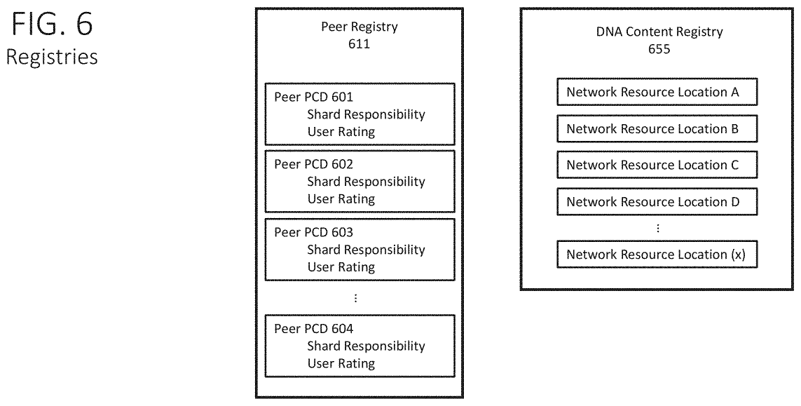

As shown in detail in FIG. 6, the invention incorporates the use of two registries. A Peer Registry 611 holds information related to all peers 601, 602, 603, 604 within the network and is referenced for requests by peers and for information about potential responsibilities (e.g., shards held, etc.) within the network. The Peer Registry 611 can be used to store and reference User Ratings, Shard Expert status, and diagnostic data. The Peer Registry 611 can be queried by peers for this information and can be used to modify User Ratings and responsibilities. A DNA Content Registry 655 holds information related to all resources and their resource locations (i.e., network addresses that allows the user to access the resource) across the network.

### Example DNA Routing Algorithm

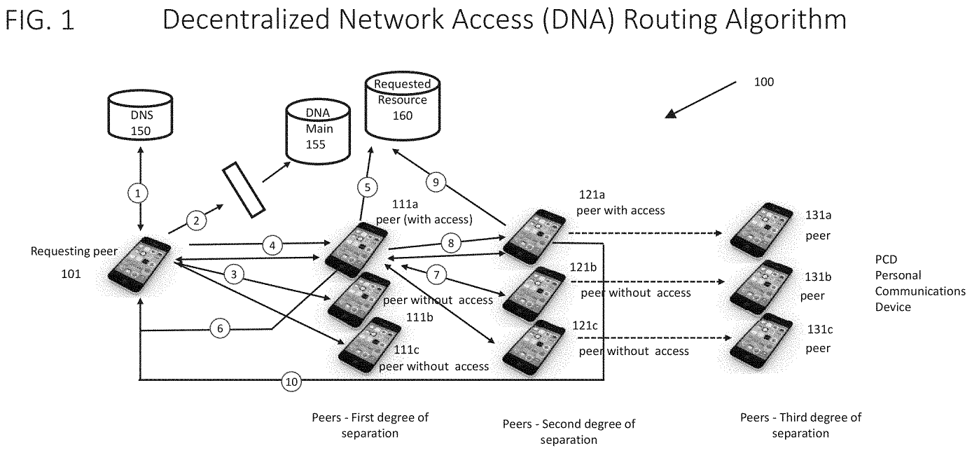

An example implementation of a DNA system and app is shown in FIG. 1. A peer 101 with DNA network access wishes to browse or access a network-based resource, such as a web site 160, for example. The peer 101 attempts to locate this resource location by requesting its web address using DNS server 150 in block 1. The peer's (101) request fails.

Upon failure of the request to the DNS server 150 and/or a timeout, in block 2, the requesting peer 101 attempts to contact the DNA main server 155 from which to access the network-based resource location. The DNA (main) server 155 simplifies network management by providing domain control. While multiple DNA servers are employed, for simplicity, a single DNA (main) server 155 is shown in FIG. 1. In block 2, the requesting peer 101 attempts to contact the DNA (main) server 155, but it is also not available (e.g., it is blocked).

Upon failure of the request to the DNA main server 155, the requesting peer 101 polls its peers 111a, 111b, 111c (first degree of separation) in block 3 to assess if any of its peers 111a, 111b, 111c have access to the requested resource location. For example, the requesting peer 101 can begin polling its peers 111a, 111b, 111c by contacting the most recent peer address stored locally in the Device Log of the requesting peer 101. If the peer with the most recent address has access to the requested resource location, then that (requested) peer 111a responds affirmatively to the requesting peer 101.

The DNA routing algorithms incorporate distributed sets of routing tables (i.e., shards) that are housed on peers on the DNA network 100. Each peer has its own routing table (i.e., Device Log) that is held locally and includes entries for its own DNA access points and a copy of the routing tables housed by its peers so that a given peer will “know” what network resources it has access to and what resources its peers have access to as well.

The local routing tables are constructed through network members (peers) who log location information of resources and add that location information to their Device Logs. So, if a peer accesses a resource on the network, a row on the routing table is created to indicate that the peer has access to this resource. In one example implementation, this table includes:

Node ID (e.g., 123456789)

Resource address (e.g., 151.101.65.67)

Resource name (e.g., CNN.com)

Last Access date/time (e.g., Jan. 1, 2021)

Peers replicate their routing tables to their peers on a periodic basis so that a given peer has both its own routing table entries and the routing table entries of its peers. When a resource is requested by a peer, that requesting peer first checks its routing table to see if the peer has the resource. If that resource is not on that requesting peer (e.g., the requested resource is located at a network location different than that of the requesting peer), the DNA routing algorithms of the requesting peer check the routing table for availability of the resource on its peers. If the resource is available on one of the requesting peer's peers, the DNA app of the requesting peer places a resource request to the peer that the local copy of the routing table indicated as having access to the resource. This “requested” peer services the request and returns the results (resource) to the requesting peer.

Upon receiving a resource location request, the requested peer checks its local routing table (Device Log) in its shard to see if there are entries that would provide access to the requested resource. The peer then replies to the requesting node with a “no access” message if no entries are found or with the address of a peer advertising access to the requested resource when an entry is found. The requesting peer then proceeds to request a resource location from a different peer.

When a peer locates the requested resource 160, that peer notifies the requesting peer 101 who selects a peer from which to access the requested resource location. The requested peer attempts to access the requested resource to attain the resource location.

The requesting peer 101 then collects the response(s) and assesses if any responses include an address with access to the resource 160. If at least one response contains an address with access to the requested resource 160, the requesting peer 101 formats a resource request directly to that peer. If a requested peer has access to the requested resource, the requested peer sends the requested resource location to the requesting peer. If no responses indicate access to the requested resource 160, the requesting peer 101 can optionally request another resource location request with a larger Max Hops value (discussed further below).

Referring again to FIG. 1, in block 4, the requesting peer 101 identified a peer 111a and then selects the peer 111a from which to retrieve the requested resource 160.

In block 5, the requested peer 111a then forwards the resource request to the requested resource 160 and receives a reply from the requested resource 160.

The requested peer 111a then sends this reply to the requesting peer 101 in block 6.

If in block 3, the requested resource 160 did not appear to be available at any of the requesting peer's peers 111a, 111b, 111c (first degree of separation), in block 7 the requesting peer 101 formats a resource location request for a deeper search for the resource that is then passed from the requesting peer's peers 111a, 111b, 111c (first degree of separation), to their peers 121a, 121b, 121c (second degree of separation) to see if the requested resource 160 is available at that next degree of separation (degree of separation from the requesting peer 101). The resource location request message includes the peer IDs for all peers that have already been contacted (exhausted peers). For example, a requesting peer 101 “crosses off” peers who have already been checked and builds a “contacted peers collection” of those checked peers so that a peer is contacted once and only once for a given request. The resource request also has a “Max Hops” parameter that determines the polling of the different peers with increasing degrees of separation (from the requesting peer 101).

As the DNA network grows, the number of potential paths to access peer network location information grows as well. The DNA systems and apps in accordance with the invention establish and maintain a decentralized Peer Registry of network user (peer) locations, such that there are multiple possible paths to identifying a peer's network location. The potential paths radiate from the requesting user (peer) to a first layer of peers. Each of the first layer of peers has paths that radiate to their peers on a second layer. This interconnection is akin to a hierarchical network topology that interconnects multiple groupings of peers (peers/PCDs) that are located on the separate layers that form a larger network. If one path is blocked by a firewall or other blockage, many other paths to the peer with the required DNA Content shard are available.

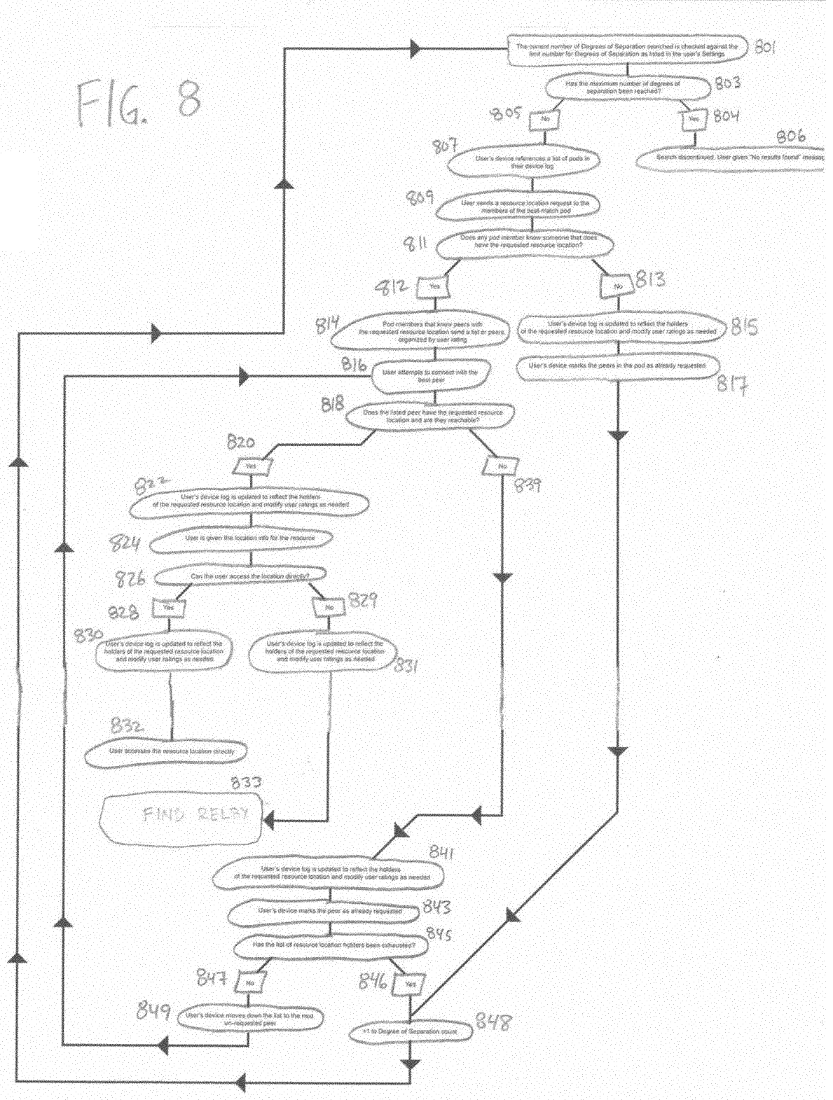

As shown in FIG. 8, the requesting peer can search for a resource through multiple degrees of separation. For example, in block 801, the application checks the current number of degrees of separation that have been searched against the maximum number of degrees of separation as listed in the user settings. In block 803, the system determines if the maximum number of degrees of separation has been reached. If the maximum number has been reached in block 804, the process stops at block 806 and the search is discontinued. The user is given a “no results found” message.

However, if in block 803 the maximum number of degrees have not been reached, the process continues in block 805 and then to block 807 where the user device references a list of Pods in their Device Log. In block 809, the user sends a resource location request to the members of the best matched Pod. In block 811, the system checks to see if any Pod member knows someone that has the requested resource location. If the Pod member does not know someone that has the requested resource location in block 811, the process continues to block 813 and then to block 815 where the users Device Log is updated to reflect the holders of the requested resource location and to modify User Ratings, as needed. The process continues to block 817 where the user's device marks the peers in the Pod as already registered. The process then continues to block 848 where a “plus one” is added to the degree of separation count, and the process returns back to block 801 and the current number of degrees of separation is again checked. The process iterates from there.

If, however, in block 811 a Pod member knows someone that has the requested resource location, the process continues to block 812 and then to block 814 where Pod members that know peers with the requested resource location send a list of peers organized by User Rating. The process continues to block 816 where the user attempts to connect with the best peer. The process then continues to block 818, and the system determines whether the listed peer has the requested resource location and whether they are reachable.

If the DNA application determines that the listed peer does not have the requested resource location or they are unreachable, the process continues to block 839 and then to block 841 where the user's Device Log is updated to reflect the holders of the requested resource location and to modify User Ratings as needed. The process continues to block 843 where the user's device marks the peer as already requested. In block 845 the process continues, and the system determines whether the list of resource location holders has been exhausted. If the list of resource location holders has been exhausted, the process continues to block 846 and then to block 848 where a “plus one” is added to the degree of separation count, and the process returns back to the start at block 801.

If the system determines in block 818 that the listed peer has the requested resource location and they are reachable, the process continues to block 820 and to block 822 where the user's Device Log is updated to reflect the holders of the requested resource location and to modify User Ratings as needed. The process continues in block 824, and the user is given the location information for the resource. In block 826 the system determines whether the user can access the location directly. If the user is able to access the location directly, the process continues to block 828 and then to block 830 where the user's Device Log is updated to reflect the holders of the requested resource location and to modify User Ratings as needed. The process stops in block 832 when the user accesses the resource location directly.

If the system determines that the user cannot access the location directly in block 826, the process continues to block 829 and then to block 831 where the users Device Log is updated to reflect the holders of the requested resource location and to modify User Ratings as needed. The process continues to block 833, and the user will find a relay. Once the network location is identified, peers can establish a network connection with the identified peer, and exchange data in a P2P path.

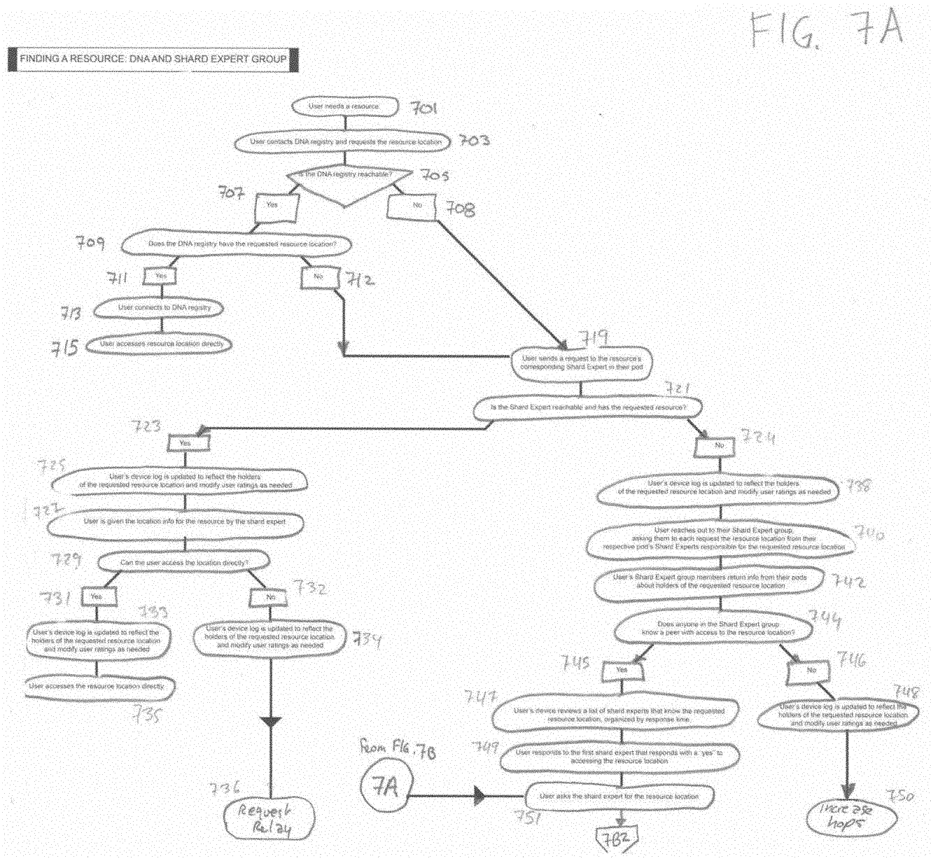

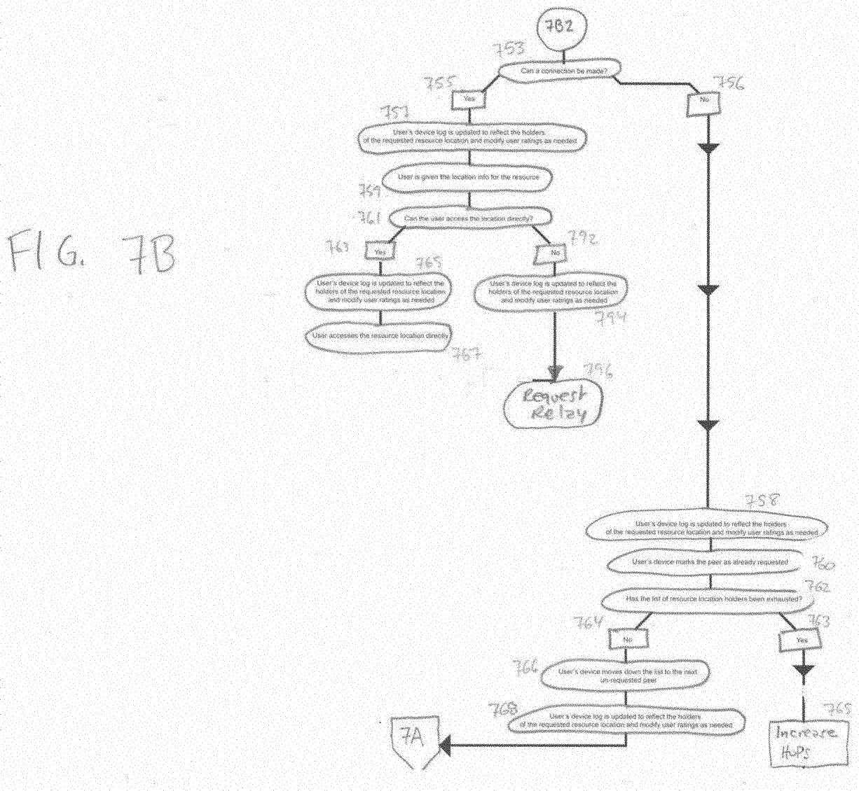

FIGS. 7A-7B provide additional details with regard to a peer finding a resource. In block 701, a user needs a resource, and in block 703, the user contacts the DNA Content Registry and requests the resource location. If the DNA Content Registry is reachable in block 705, the process moves to block 707. If the DNA Content Registry is not reachable in block 705, the process moves to block 708 described below. When reachable in block 707, the invention checks to see if the DNA Content Registry has the requested resource location in block 709. If the DNA Content Registry has the requested resource in block 711, the user (peer) connects to the DNA Content Registry in block 713, and in block 715, the user (peer) accesses the resource location directly.

If the DNA Content Registry is not reachable in block 708, or if the query as to whether the DNA Content Registry has the requested resource location is negative in block 712, the process moves to block 719 where the user sends a request to the resource's corresponding Shard Expert in their Pod. In block 721, the application determines whether the Shard Expert is reachable and has the requested resource. If the Shard Expert is reachable and has the requested resource, the process moves to block 723. Otherwise, the process moves to block 724.

Moving on from block 723, the user's Device Log is updated to reflect the holders of the requested resource location and to modify User Ratings as needed (block 725). In block 727, the user is given the location information for the resource by the Shard Expert. In block 729, the application determines whether the user can access the location directly. If the user can access the location directly, the process moves to block 731 and then to block 733 where the user's Device Log is updated to reflect the holders of the requested resource location and to modify the User Ratings as needed. Then, the process ends in block 735 when the user accesses the resource location directly. If the user cannot access the location directly in block 729, the process moves to block 732 and then to block 734 where the user's Device Log is updated to reflect the holders of the requested resource location and to modify User Ratings as needed in block 734. The process then ends in block 736 when the user requests a relay.

If the Shard Expert is not reachable or does not have the requested resource in block 721, the process moves to block 724 and to block 738 where the user's Device Log is updated to reflect the holders of the requested resource location and to modify User Ratings as needed. The process continues to block 740 where the user reaches out to their Shard Expert Group and asks them to each request the resource location from their respective Pod's Shard Experts responsible for the requested resource location. In block 742, the user's Shard Expert Group members return information from their Pods about holders of the requested resource location. In block 744, the invention determines if anyone in the Shard Expert Group knows a peer with access to the resource location.

If, in block 744, no one in the Shard Expert Group knows a peer with access to the resource location, the process continues to block 746 and then to block 748 where the user's Device Log is updated to reflect the holders of the requested resource location and to modify the User Ratings as needed. The process then ends at block 750 and an increased number of hops are needed.

If, in block 744, a peer in the Shard Expert Group knows a peer with access to the resource location, the process continues to block 745 and then to block 747 where the user's device reviews a list of Shard Experts that know the requested resource location (organized by response time). In block 749, the user responds to the first Shard Expert that responded with a “yes” to accessing the resource location. The process then moves to block 751 where the user asks the Shard Expert for the resource location. The process then moves to 7B2 in FIG. 7B.

In FIG. 7B, the process continues at block 753 where a connection is attempted. If a connection can be made, the process continues in block 755 and then on to block 757 where the user's Device Log is updated to reflect the holders of the requested resource location and to modify User Ratings as needed. The process continues in block 759 where the user is given the location information for the resource. In block 761, the user attempts to access the location directly. If the user is successful, the process continues in block 763 and then to block 765 where the user's Device Log is updated to reflect the holders of the requested resource location and to modify User Ratings as needed. The process ends in block 767 where the user accesses the resource location directly.

If a connection cannot be made in block 753, the process continues to block 756 and then on to block 758 where the user's Device Log is updated to reflect the holders of the requested resource location and to modify User Ratings as needed. In block 760 the user's device marks the peer as already requested. In box 762 the system determines whether the list of resource location holders has been exhausted. If the list of resource location holders has been exhausted, the process continues to block 763 and then ends at block 765 where the number of hops can be increased.

If the list of resource location holders has not been exhausted, the process continues to block 764 and then to block 766 where the user's device moves down the list to the next unrequested peer. The process continues in block 768 where the user's Device Log is updated to reflect the holders of the requested resource location and to modify User Ratings as needed. The process loops back to FIG. 7A at block 751 where the user asks the next Shard Expert for the resource location.

In this fashion, the requesting peer's DNA app calculates the most efficient search path to locate a DNA Content shards where the sought peer's network location is stored.

An example implementation of the invention illustrates the manner in which the hops are used to locate a resource. As shown in FIG. 1, DNA network peers (e.g., 101, 111a, 111b, 111c, 121a, 121b, 121c, 131a, 131b, 131c) are linked to other DNA network peers that define the next hop for any communications across the DNA network. A hop can be thought of as a packet of information passed from one network segment to the next network segment (e.g., from a first degree of separation to a second degree of separation). A hop count refers to the number of intermediate segments or devices through which data must pass between source (e.g., requesting peer 101) and destination (requested peer). Peers on the network are established through a user interface to a DNA software app running on a peer. Peers are established through an application specific set of rules. The peers can be defined as chat peers, supernodes, geographic peers, and proximity peers. Chat peers include social contacts with whom content sharing and common resource requests are more likely. Supernodes are designated and provided by the DNA network provider (i.e., a party that establishes the network) and other parties (e.g., distributors who provide resources to the network). These are typically server class routing nodes that have high capacity and high availability. Geographic peers are nodes that can be assigned in widely varying geographies to provide routing of requests around network blockages in the local geography. The geographic peers provide diverse and resilient network access points. Proximity peers are peers that are on the same network segment including, for example, those having the same degree of separation, or having Bluetooth or NFC connectivity to the peers in their network segment.

A current hops value is used to time out (retire) the request after a certain number of hops. In one example implementation of the invention, the request message is formatted as follows:

| | |
|---|---|
| Requesting Node ID | 123456789 |
| Requested resource name | www.cnn.com |
| Contacted Nodes Collection | 1234; 4567; 1591 |
| Number of current hops | 2 |
| Max number of hops | 2 |

As outlined above, when no peers 111a, 111b, 111c (first degree of separation) have access to the requested resource 160, the requesting peer 101 requests a deeper search, including those peers with a second degree of separation from the requesting peer 101. As shown in block 7, each first degree of separation peer 111a, 111b, 111c then polls its peers 121a, 121b, 121c and potentially their peers 131a, 131b, 131c, and so on, to assess if any of these peers have access to the requested resource location. The polling of the different peers with increasing degrees of separation stops when the Max Hops value is reached.

The Max Hops value provides the total number of hops to be made in searching for a resource. The requesting peer is hop 1. The requesting peer's peer is hop 2. So, in the prior example, the Max Hops=2 setting limits the search to the requesting peer's immediate peers (first degree of separation). However, if no access to the requested resource is found, then a request with a larger Max Hops value (e.g., Max Hops=4) can be issued. When a resource location request is received by a peer, the peer checks its local routing table in its subdirectory to see if the peer or its peers has access to the resource. If the peer does not have access to the requested resource, then the peer checks the Max Hops value, and if the Max Hops is greater than the current hops, the peer increments the current hops number, updates the “Contacted Peers Collection” to list its peers and itself, and forwards the request to all peers that are not already on the Contacted Peers Collection. If any of these “next hop” peers have access to the requested resource, they reply directly to the requesting peer instead of routing the response via an intermediate peer.

DNA resource requests that have been successfully completed are optionally cached on the computing device (i.e., PCD) of the requesting peer 101 so that future requests by a peer or its peers can have this content served from this node.

### Example DNA Relay Algorithm

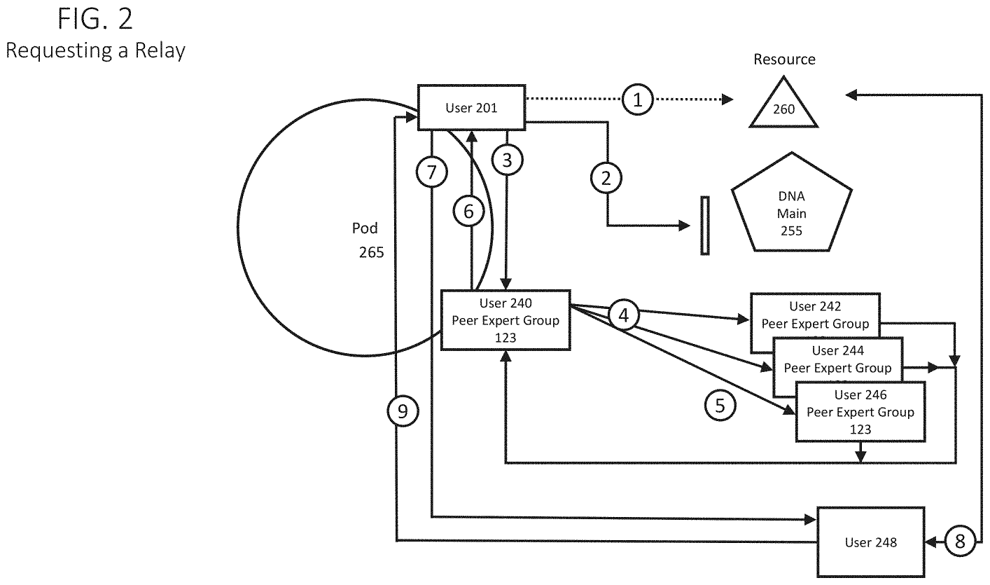

In an example DNA Relay Algorithm shown in FIG. 2, the DNA (Distributed Network Access) computer architecture in accordance with the invention includes systems and methods of peers providing access to resources that would be otherwise inaccessible to other peers across a wide mesh network. These methods of accessing a resource through another node (peer) on the wide mesh network is called a relay. The node that is providing the relay is known as a relay node.

In one example of the invention, a requesting peer 201 is a DNA node that is aware of the network location of a resource 260 it would like to access, but the requesting peer 201 cannot access the resource from their PCD (see block 1 in FIG. 2). The requesting peer 201 knows the location of the desired resource 260. In block 2, requesting peer 201 attempts to access DNA Main 255 to access resource 260, but is unable to. Unable to access resource 260 themselves, requesting peer 201 reaches out to a Peer Expert 240 that is within requesting peer 201's Pod 265 and in block 3 sends a request for relay access to resource 260, providing the resource location for resource 260. Peer Expert 240 receives the relay request and contacts their Peer Expert Group (peers 242, 244, and 246) in block 4, requesting that the Group 242, 244, 246 provide a list of optimal peers to provide the relay. A Peer Expert Group is related to a Shard Expert Group with some distinct differences. The Shard Expert Group relates to the DNA Content Registry and all hold the same shard from the DNA Content Registry, while the Peer Expert Group is a collection of peers, that combined, holds a complete Peer Registry. A peer will reference the Group for information regarding peers within the DNA network. The peers are rated on their ability to serve as a relay, their reliability, and their behavior within the DNA network. An optimal peer is a peer that has access to the requested resource, has a stable connection with the network, has a high User Rating based on the accuracy of information they can provide, and has past good conduct within the DNA network. The Peer Experts in the Peer Expert Group each reference their peer shard for peer information to determine an optimal relay node. In block 5, each Peer Expert 242, 244, 246 returns to Peer Expert 240 a list of optimal relay nodes and their locations within the wide mesh network. Peer Expert 240 references their peer shard for peer information to determine an optimal relay node and to add their potential relay nodes to the list of potential relay nodes. In block 6, Peer Expert 240 sends the list of potential relay nodes to requesting peer 201. Requesting peer 201's PCD receives the list of potential relay nodes, and the DNA app automatically selects a potential relay node based on optimal characteristics. Requesting peer 201 determines that peer 248 is the optimal peer to provide a relay to access resource 260. In block 7, requesting peer 201 contacts peer 248 and sends a relay request and the resource location of resource 260. Peer 248 establishes access to resource 260 in block 8 before directly connecting with requesting peer 201 and providing relay access to resource 260 in block 9.

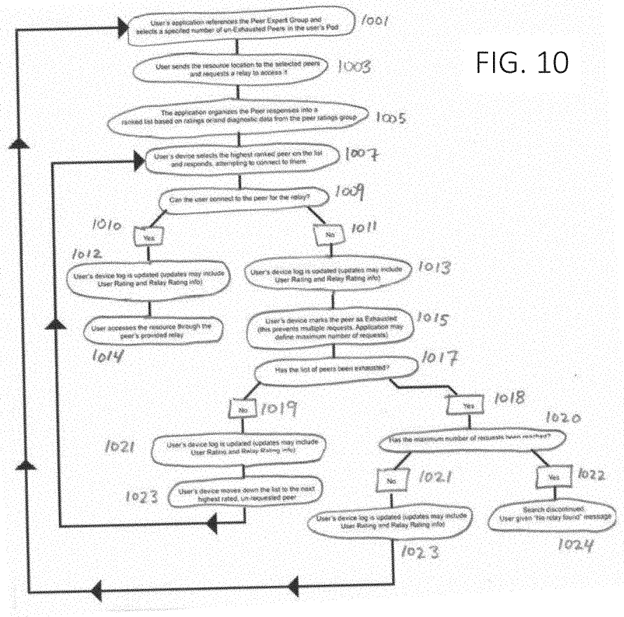

FIG. 10 provides additional details when a user needs a relay to find a resource. The process starts in block 1001 when a user's application references the Peer Expert Group and selects a specified number of unexhausted peers in the user's Pod. The process continues to block 1003 where the user sends the resource location to the selected peers and requests a relay to access it. In block 1005 the application organizes the peer responses into a ranked list based on ratings and or diagnostic data from the peer ratings group. In block 1007 the user's device selects highest ranked peer on the list and responds, attempting to connect to them. In block 1009, the system determines whether the user can connect to the peer for the relay. If the user can connect to the peer for the relay, the process continues to block 1010 and then to block 1012 where the user's Device Log is updated. Updates can include User Ratings relay ratings and other updating information. In block 1014 the process ends when the user accesses the resource through the peers provided relay.

If the user cannot connect to the peer for the relay in block 1009, the process continues to block 1011 and then to block 1013 where the user's Device Log is updated. The updates can include User Ratings, relay ratings, and other updated information. The process continues to block 1015 where the user's device marks the peer as exhausted. This prevents multiple requests from being made of the same peer. The application can define the maximum number of requests. The process continues to block 1017 where the system determines whether the list of peers has been exhausted.

If the system determines in block 1017 that the list of peers has not been exhausted, the process continues to block 1019 and then to block 1021 where the user's Device Log is updated again, these updates may include user relay ratings and other updating information. The process continues to block 1023 where the user's device moves down the list to the next highest rated unrequested peer. The process then returns to the beginning at block 1001 where the user's application references the Peer Expert Group and selects a specified number of unexhausted peers in the user's Pod. The process then continues. If the system determines in block 1017 that the list of peers has been exhausted, the process moves to block 1018 and then to block 1020 where the system determines whether the maximum number of requests has been reached. If the maximum number of requests has been reached, the process continues to block 1022 and then stops in block 1024 where the search is discontinued. The user is given a “no relay found” message. In this way, a user can employ a relay to find a resource.

### Example DNA Content Registry Distribution and Grouping of Peers

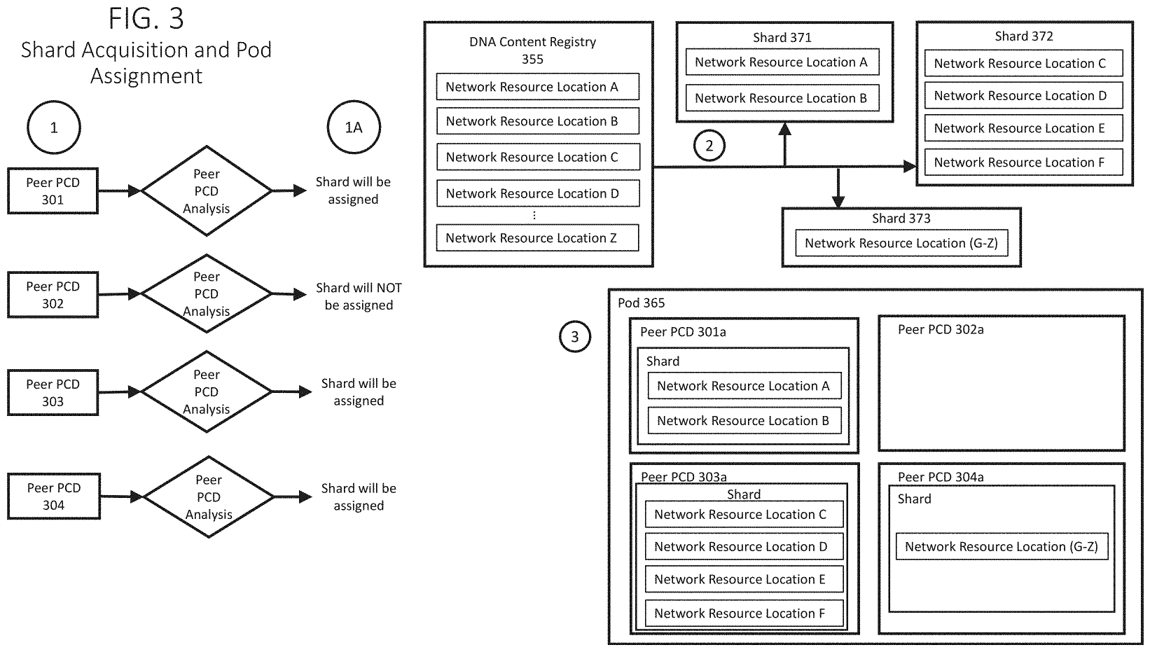

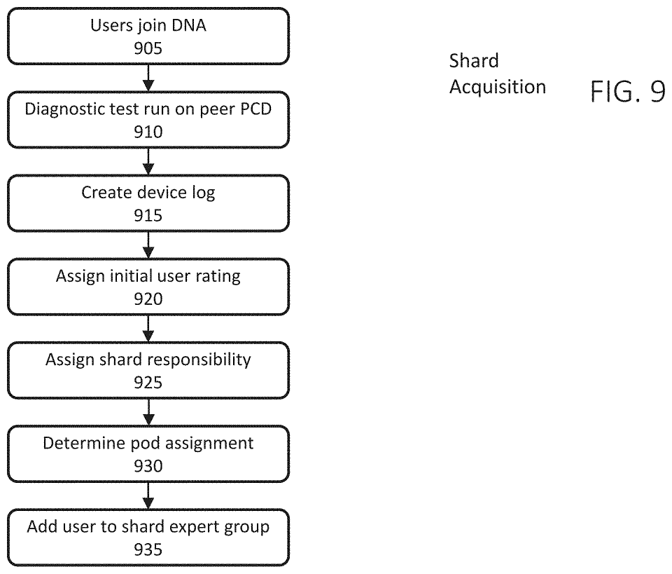

In the example DNA Content Registry Distribution shown in FIGS. 3 and 9, the DNA computer architecture in accordance with the invention includes systems and methods of peer PCDs acquiring segments (shards) of the DNA Content Registry 355. Shards are created from the DNA Content Registry 355 and distributed to peers that are assigned a shard responsibility. Peers are organized into Pods 365, which are groups of peers that may or may not have a shard responsibility but collectively hold a complete DNA Content Registry.

As shown in block 1, during the process of joining the wide mesh network, a peer PCD 301, 302, 303, 304 is analyzed by the DNA apps of the invention to determine the capabilities of the peer PCDs 301, 302, 303, 304 and potential responsibilities within the network. This analysis takes into account the peer PCDs 301, 302, 303, 304 network speed, reliability regarding access to the network, capacity for holding Shards, and geolocation. Based on this analysis, a peer can be assigned a shard responsibility within the network as shown under block 1A. The size of the shard assigned to a peer is determined by the previous analysis, with some peer PCDs with lower capabilities, such as peer PCD 301, being assigned smaller Shards while Peer PCDs with higher capabilities, such as peer PCD 303, being assigned larger shards. Not all peers are assigned shards.

In some example implementations of the invention, the various shards of the DNA Content Registry are divided onto the peer PCDs in different sizes, with the size of the DNA Content Registry shard determined by characteristics of the peer's DNA network account. As outlined above, the peer's DNA network account is an account that a peer creates and uses when operating within the DNA network, and it includes information about the peer's PCD, the PCD's capabilities, the peer PCD interactions with other peers, and the peer PCD's responsibilities within the DNA network. As shown in FIG. 9, new users are joined to the network in block 905, unless they choose to opt out.

In block 910, the DNA app runs a diagnostic test on the peer PCD to assess its capabilities. The diagnostic test can determine the geolocation, size of the shard that the peer's PCD should be assigned, and its viability in providing relays. A relay is a network peer that acts as a proxy for the requesting peer for resources that the requesting peer cannot reach.

In block 915, a Device Log is created locally, and in block 920 an initial User Rating is assigned based on the diagnostic data gathered. The initial User Rating may take into account network speed, data usage, device hardware, and other characteristics of the peer PCD. The peer interactions can be stored in the log file (Device Log) stored locally on the peer's PCD. The log file is updated locally and shared with the DNA Content Registry and Peer Registry to update User Ratings, which can be used to determine optimal relays.

In block 925, a user is assigned a shard responsibility based on the diagnostic data gathered. Responsibilities can include holding segments (shards) of the DNA Content Registry and providing access and relays to resource locations.

In block 930, a user can be asked questions to determine Pod assignments. The questions can be related to region, interests, preferences, and other biographic and demographic traits of the user and of the peer PCD.

In block 935, a user is added to a Shard Expert Group that corresponds to their shard, or the user is approved for membership in the DNA without being a Shard Expert. A Shard Expert Group is a group of peers that all hold the same segment of the DNA Content Registry.

Returning to FIG. 3, once it is determined that a peer will be assigned a shard, in block 2 the systems and methods of the invention create a shard 371, 372, 373 from the DNA Content Registry 355 that is appropriate for the peer's capabilities based on the prior analysis. Block 3 shows peer 301a is now a Shard Expert on the content of their Shard 371 and will be responsible for handling requests from other peers regarding that content.

The peers 301a, 302a, 303a, 304a are assigned to a Pod 365 automatically. The invention carries out this method in a way that results in the Shards 371a, 372a, 373a held by peers 301a, 303a, 304a within the Pod 365 collectively forming a complete DNA Content Registry. Peers 302a with no shard responsibilities may be assigned to a Pod 365 based on geolocation. Not all peers within a Pod 365 must have a shard responsibility.

Example Shard Propagation from DNA Main

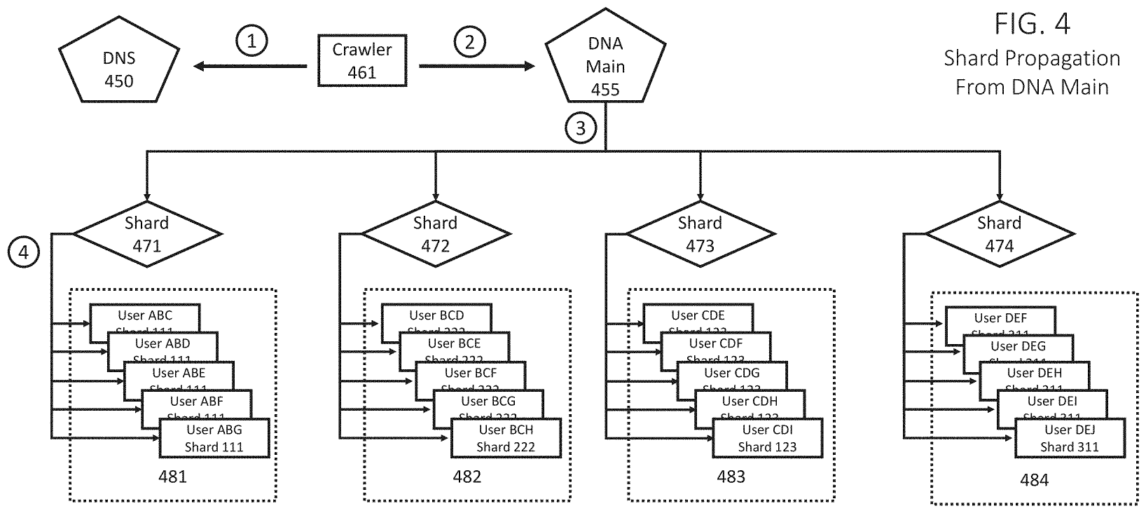

In the example shard propagation from the DNA Main 455 shown in FIG. 4, the DNA computer architecture in accordance with the invention includes systems and methods of propagating updates of resource locations among all peers and shards that hold the resource locations in question. By maintaining version control of resource location information, the systems and methods of the invention maintain accuracy and efficiency when peers attempt to locate and access resources. These methods also allow for easy encompassing of new resources found through DNS 450 into the DNA Content Registry 455.

One method by which the invention maintains version control of resource locations is through a server crawling the DNS for updated and new resources, caching those resource locations on the DNA Main 455, and DNA Main 455 updating all holders of those resource location changes. As shown in block 1, web crawler 461 searches the DNS 450 for resources and caching resource locations. In block 2, the crawler 461 updates DNA Main 455 with all cached resource locations. In block 3, DNA Main 455 updates all resource locations within its DNA Content Registry. DNA Main 455 determines by way of version control that shard 471, shard 472, shard 473, and shard 474 are not current. DNA Main 455 propagates updates for each shard 471, 472, 473, 474 to the corresponding Shard Expert Group 481, 482, 483, 484. A Shard Expert Group is a collection of Shard Experts (not labeled separately) from separate Pods, each of whom hold some portion of the same DNA Content Registry information in their shard. A peer will use a Shard Expert Group to reach out to other Pods for resource locations and relays. Shard Expert Groups will grow as the network grows. In this way, version control is maintained when new or updated resource locations are acquired.

Example Shard Propagation from Shard Experts

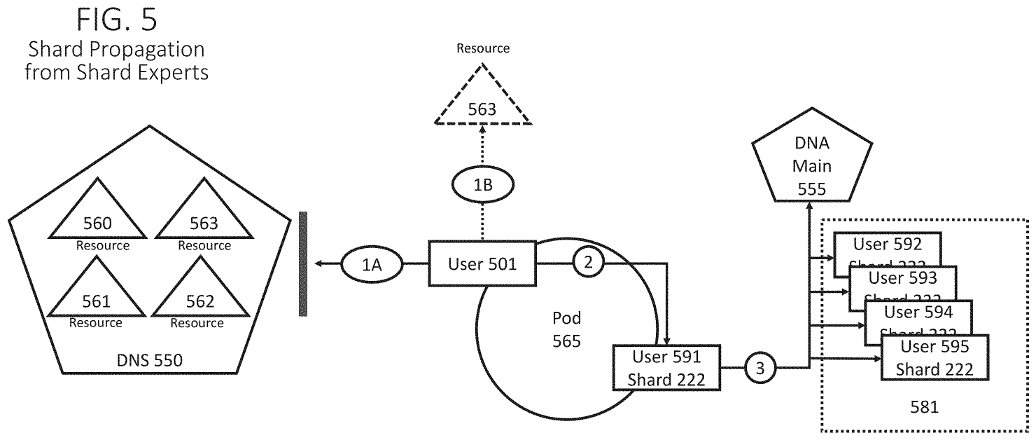

In the example shard propagation from Shard Experts shown in FIG. 5, the DNA computer architecture in accordance with the invention includes systems and methods of propagating updates of resource locations among all peers and shards that hold the resource locations in question. By maintaining version control of resource location information, the systems and methods of the invention maintain accuracy and efficiency when peers attempt to locate and access resources. These methods also allow for easy encompassing of new resources found through DNS 550 into the DNA Content Registry 555.

One method by which the invention maintains version control of resource locations is through updates from any peer in the network to every holder of the resource location in question. In this example, peer 501 knows the resource location of resource 563 and attempts to access resource 563. Resource 563 is inaccessible, which could be due to the resource location being inaccurate or out of date as shown in block 1B, or due to peer 501 being blocked from accessing resource 563 on the DNS 550 as shown in block 1A. In both scenarios, in block 2 peer 501 contacts the Shard Expert 591 in their Pod 565 that is responsible for the location of Resource 563. This Shard Expert 591 holds shard 222. Shard Expert 591 receives the update from peer 501 and updates their own shard 222 with the new location information. In block 3, Shard Expert 591 then propagates the update to all holders of the updated resource location in shard 222. This includes the Shard Expert Group 581 for shard 222 as well as DNA Main 555. While only one “DNA Main” is shown, any number of DNA Main nodes can exist, and each will have the update propagated to them as each would be holders of the resource location for Resource 563.

Through this method, any holder of a shard that receives an update related to their shard can propagate that update to all other holders of the same shard. The systems and methods of the invention make version control of resource location information accurate, automatic, and efficient.

Further, any peer that discovers a new resource or changes regarding a resource location, regardless of shard responsibility or shard held, updates the Shard Expert responsible for the new or updated information. The Shard Expert then propagates the updates to all holders of the same shard. This allows for rapid absorption of new and updated resource information into the DNA system.

### Privacy Considerations

In many conventional systems, resource access records can compromise privacy. To address this issue, the systems and methods of the invention can globally block replication of resource access to certain peers or on a resource-by resource-basis. In one example implementation of the invention, a DNA version of “Private Browsing” does not log access to a given resource on the DNA network. Likewise, that replication of access information is restricted to known, trusted peer devices.

### Marking Failed Locations

It is possible that the DNA routing tables can be “poisoned” by bad actors seeking to disrupt access to controversial resources. If a resource location request that is returned by a peer does not resolve to the correct resource location, the end user (requesting peer) can mark that responding (requested) peer as a “bad” peer, which will be logged in the requesting peer's Device Log and propagated to the Peer Registry, ultimately affecting the bad peer's User Rating and potentially restricting access to this peer.

### Additional System and Method Enhancements

One way to further optimize the search for the location of resources is to split the DNA Content Registry. To optimize performance, the system utilizes two features of each requested resource, namely where the resource is located, and which peers have access to the resource. For example, the DNA Content Registry is a master routing table that can be split into X number of pieces (e.g., 100,000 pieces). This split results in smaller tables 1 through 100,000. The systems then assign a routing table to each peer, and create a Pod of 100,000, so that the system identifies a sub universe of peers who, together, have the complete routing table (DNA Content Registry). The system tags the peers (resource location) in a logical way that includes its table number (identifying where to find peers who have its location information). The systems also assign unique identifying characteristics to each routing table (e.g., geography, subject matter, language used in search, and other identifying characteristics). In this way, a searcher who has information related to the characteristics of the resource he is looking for is able to do a smarter, more efficient search. Further, the systems create a second routing table of the locations visited by each peer to maximize efficiency when the peer returns.

If the searching (requesting) peer has the table number for the requested resource, it can look up which peer in its Pod has that table number (peer with table number), and reach out in a single hop to retrieve the location information so that it can connect to the requested resource. If the peer with table number is dark, the searching peer will revert to going outside of its own peer routing table Pod and use the method described above.

If the searching (requesting) peer does not have the table number for the requested resource but does have identifying characteristics of the resource (e.g., geography, subject matter, language used in search, etc.) that requesting peer can do a smarter search through an algorithm that calculates and determines the peer most likely to have the requested resource. The algorithm matches identifying characteristics with the characteristics of the routing table to request the highest matching table first, etc.

The systems and methods in accordance with the invention provide multiple communications (e.g., data delivery) paths through a network. The DNA apps establish a network of users who can become nodes on potential paths, sharing location information of requested resources through a network of peers, where peers are other network users on personal computing devices. The systems and methods of the invention provide universal access around firewalls and other blocked network paths, and provide additional layers of reliability to networks. The invention overcomes many shortcomings of current Internet browsers' use of a single path to a web resource that either works, or fails.

We claim:

1. A method of distributing registry information to peers on a decentralized computer network, the method comprising:
requesting, by a requesting peer, a network resource from a plurality of additional peers,
wherein the requesting peer is a peer on the decentralized computer network interconnected to the plurality of additional peers, and
wherein the peers on the decentralized network are configured to discover and deliver network resource locations and network resources to other peers on the network, and no pre-established route or address, nor pre-defined peer or group of peers, is responsible for accessing and/or delivering the network resource location or the network resource; and
receiving, by the requesting peer, an affirmative response from at least one of the plurality of additional peers; and
wherein the affirmative response indicates that the at least one additional peer has access to the requested network resource.

2. A method of claim 1 further comprising at least one of the group of:
receiving, by the requesting peer, the network resource location of the requested network resource from the at least one additional peer and
receiving, by the requesting peer, the network resource from the at least one additional peer.

3. A method of claim 1, wherein the registry information includes a DNA Content Registry of network resource locations identifying a location of the requested network resource.

4. A method of claim 1, wherein requesting a network resource includes:
polling a first set of peers, by the requesting peer, wherein the first set of peers are a subset of the plurality of additional peers having a first degree of separation.

5. A method of claim 1, wherein the registry information is a DNA Content Registry of network resource locations, and wherein the method further comprises:
sharding the DNA Content Registry of network resource locations into shards, wherein sharding includes dividing the DNA Content Registry, and wherein the shards are sub registries of the DNA Content Registry; and
distributing the shards to at least one of the plurality of additional peers.

6. A method of claim 5, wherein at least one of the plurality of additional peers is formed into one or more Pods, wherein a Pod is a group of peers holding a shard of the DNA Content Registry, and wherein the method further comprises:
storing, by the one or more Pods, a shard such that when the Pod's shards are combined, the combination of shards constitutes a complete DNA Content Registry.

7. A method of claim 6, further comprising:
delivering, by a shard expert in the one or more Pods, a network resource location associated with their shards to at least one of the plurality of additional peers, wherein the shard expert is a designated holder of a shard responsible for sharing their shard with any requesting peer.

8. A method of claim 6, further comprising:
determining, by the requesting peer, a shards that includes a network resource location of the requested network resource;
identifying a shard expert based on the determined shards, wherein the shard expert is a responsible peer that has the network resource location of the requested network resource; and
requesting, by the requesting peer, the location of the network resource from the shard expert.

9. A method of claim 8, wherein the shard expert does not have the requested network resource location, and the method further comprises:
requesting an alternative network resource location from a shard expert group, wherein the Shard Expert Group is a collection of Shard Experts from separate Pods, each of whom hold some portion of the same DNA Content Registry information in their shard.

10. A method of claim 4, wherein the first set of peers who have been polled for the network resource location do not have the network resource location, and wherein the method further comprises:
further requesting the network resource location, by at least one peer in the first set of peers who has been polled for the network resource location, until the at least one peer in the first set of peers receives the network resource location and returns it to the requesting peer or the further request is failed.

11. A method of claim 6, wherein a shard expert in the one or more Pods updates network resource locations to peers in the same one or more Pods.

12. A method of claim 6, wherein a peer in the one or more Pods receives a network resource location update for a shard that they do not hold and updates the network resource location to a shard expert in the same Pod that is designated to hold the network resource location.

13. A method of claim 1, wherein the peers on the decentralized network record their interactions with other peers in a Device Log.

14. A method of claim 13, wherein the Device Logs are uploaded to a Peer Registry to record reliability and suitability for responding to and resolving peer responsibilities.

15. A method of claim 14, wherein the Peer Registry provides peer characteristics to requesting peers upon request and prior to connecting with another peer.

16. A method of claim 15, wherein the peer characteristics include a success rate of a peer in delivering network resource locations.

17. A method of sending and receiving resources to and from peers over a peer-to-peer network, wherein the resources are accessed through relay nodes based on a registry of resource locations, wherein any and all peers may discover and deliver resources or resource locations to any other peer, and no pre-established route or address, or pre-defined peer or group of peers, is responsible for accessing and/or delivering the resource or resource location, and wherein establishing and accessing the relay nodes includes:
requesting, by a requesting peer, relay suitability characteristics from a Peer Registry;
receiving, by the requesting peer, a relay node location based on the relay suitability characteristics that meet relay requirements of the requesting peer; and
connecting, by the requesting peer, to the relay node location.

18. A method of claim 17, wherein the requesting peer contacts other peers on the peer-to-peer network to request the relay to deliver the requested resource until the requesting peer receives the resource, or the request is failed.

19. A method of claim 17, wherein the relay node is established based on its relative processing ability to access the requested resource, and wherein the relative processing ability includes responding to the requesting peer that the relay node has access to the requested resource, and wherein the relay node is accessed by providing the requesting peer with access to the requested resource.

20. A method of claim 17, wherein an optimal relay node is determined based on relay node's capabilities, reliability, and conduct within the network, and wherein the peer's capabilities and reliability and conduct include at least one of the group of network status, connection speed, connection reliability, geo location, resource access, interactions with other peers, and DNA account information.
